(19) United States
(12) Patent Application Publication
(10) Pub. No.: US 2020/0065130 A1
(43) Pub. Date: Feb. 27, 2020

(54) METHOD AND DEVICE FOR MANAGING VIRTUALIZED SOFTWARE FUNCTIONS IN A NETWORK

(71) Applicant: ORANGE, Paris (FR)

(72) Inventors: Ruan He, Chatillon Cedex (FR); Jamil Chawki, Chatillon Cedex (FR)

(21) Appl. No.: 16/467,748

(22) PCT Filed: Nov. 30, 2017
(86) PCT No.: PCT/FR2017/053328

§ 371 Date: Jun. 7, 2019

(30) Foreign Application Priority Data
Dec. 7, 2016 (FR) 1662063

(51) Int. Cl. G06F 9/455; H04L 12/24; G06F 9/50

(52) U.S. Cl. CPC G06F 9/45558; H04L 41/0806; G06F 2009/4557; G06F 2009/45595; G06F 9/5077

(57) ABSTRACT

A method for managing virtualized software functions in a communication network includes: receiving a data model describing the functionality of a virtualized software function; generating a configuration interface defining the functionality, the interface being intended to be used for invoking the virtualized software function; generating and installing a first software agent, which implements the configuration interface, the first agent being configured to allow, when it is invoked, the calling of a virtual machine implementing the virtualized software function.

### BACKGROUND OF THE INVENTION

The invention lies in the general field of the virtualization of functions in a telecommunication network.

It is recalled that network function virtualization (NFV) designates the implementation of virtualized network software functions, on an infrastructure, for example cloud-based (or “cloud computing”), these functions being able to operate on generic computing hardware and be instantiated or positioned in diverse locations of the network as a function of the operators' needs.

FIG. 1 represents an architecture defined by the ETSI (European Telecommunications Standards Institute) within the framework of the “NFV” project, this architecture (hereinafter “NFV architecture”) being compliant with the telecommunications management network (TMN) model of ITU-T standards M.3010, M.3400.

In accordance with this NFV architecture, virtualized software functions VNF (“Virtual Network Function”) execute on an infrastructure NFVI (“NFV Infrastructure”), for example cloud-based, composed of basic hardware resources RM able to implement for example network operations, calculation operations, storage operations.

Each virtualized software function VNF is implemented by one or more VNFC components also called “virtual machine(s)”. At the functional level, each virtualized software function VNF is managed by a management element EM (“Element Manager”), these management elements EM being linked with operational and business applications AP (“Operational Support System” OSS and “Business Support System” BSS).

In accordance with this NFV architecture, the deployment, the execution and the utilization of the virtualized software functions VNF are driven by management and utilization functions MANO (“Management and Orchestration”) comprising:
an NFVO orchestrator, by interaction with the operational and business applications AP and in charge of the life cycle of the network services;
a VNF manager, by interaction with the management elements EM and in charge of the life cycle of the virtualized software functions VNF;
a VIM (in English “Virtualized Infrastructure Manager”), in charge of managing the hardware resources RM of the infrastructure NFVI.

In the current state of the art, when a new virtualized software function VNF is installed in the network, the administrator of this network must manually add a management element EM dedicated to this function.

The invention proposes a mechanism for managing the virtualization of a network which does not present these drawbacks.

### SUBJECT AND SUMMARY OF THE INVENTION

To this effect, the invention relates to a method for managing the virtualized software functions in a communication network. This method comprises:

a step of receiving a data model describing the functionality of a virtualized software function;

a step of generating a configuration interface defining said functionality, said interface being intended to be used to invoke said virtualized software function;

a step of generating and installing a first software agent which implements this configuration interface, this first agent being configured to allow, when it is invoked, the calling of a virtual machine implementing the virtualized software function.

Correlatively, the invention relates to a device for controlling the virtualized software functions in a communication network. This device comprises:

a module for receiving a data model describing the functionality of a virtualized software function;

a module for generating a configuration interface defining this functionality, this interface being intended to be used to invoke the virtualized software function;

a module for generating and installing a first software agent which implements this configuration interface, this first agent being configured to allow, when it is invoked, the calling of a virtual machine implementing said virtualized software function;

a module configured to, when it is called to invoke said virtualized software function, call a virtual machine implementing the virtualized software function.

Thus, and in a general manner, the invention proposes to enrich the SDN architecture so as to allow the management of virtualized software functions.

It is recalled that the SDN architecture (“Software-defined Networking”) proposes to decouple the network's control functions from the functions for conveying the data properly speaking, so as (i) to allow the control of the network by programmable software functions and (ii) to isolate the underlying infrastructure of the network from the network applications and services. According to recommendation Y.3300 (“Framework of software-defined networking”) of the standardization body ITU-T (“International Telecommunication Union—Telecommunication”), the SDN architecture is defined as a set of techniques making it possible to program, to orchestrate, to control and to directly manage the resources of the network, thereby facilitating the design, the provision and the utilization of network services in a dynamic and upgradable manner.

The SDN control layer, or SDN controller, provides a means for dynamically controlling the behavior of the resources/elements of the network according to the instructions of an SDN application. The SDN applications specify how the network resources must be controlled and allocated, by interacting with the SDN control layer via the application control interfaces NBI (“North Bound Interface”).

The command information of the SDN control layer heading for the network resources/elements is thereafter delivered via resource control interfaces SBI (“South Bound Interface). The configuration and/or the properties exposed to the SDN applications are abstracted by means of information and data models.

This SDN architecture thus allows the implementation of a programmable and flexible software platform (so-called “SDN platform”) offering a global and logic view of the network and dynamic management of the heterogeneous resources of the network. The SDN platform is open to a set of interfaces, notably SNMP, Netconf, Openflow and PCEP.

More precisely, and with reference to FIG. 2, the SDN architecture is structured as three main layers, mutually separated by the interfaces SBI, NBI, namely:
a network resources layer consisting of physical or virtual network elements NE, for example routers, switches, contents distribution networks (or “Content Delivery Network”, CDN);
an SDN controller SDN-CTRL comprising functions for abstraction and programming of the network elements NE of the network resources layer and offering basic service manager such as the management of the associated nodes and links;
a layer of network application services NAP (or “Network Applications”) comprising a set of applications for management (for example VPN management), supervision, connectivity toward a platform of a cloud network.

FIG. 3A schematically represents the OpenDaylight model-oriented technology proposed by the consortium of the same name, and allowing an SDN controller to take new network elements NE into account dynamically.

More precisely, when a new network element NE joins the network, it registers itself, in the course of a step E1, with the SDN controller SDN-CTRL, by sending it, via the interface SBI, a model M describing its functionality.

In the course of a step E2, the SDN controller SDN-CTRL generates a network interface (namely a java class Network Interface) on the basis of the model M, and then in the course of a step E3 an agent NE-P (Network Element Plug-In).

This agent allows a control module 292 of the SDN controller SDN-CTRL to access the network element NE and to control it (in the course of a general step E10).

FIG. 3B represents the sending, by a network element NE, of the model M to the SDN controller SDN-CTRL (step E1) and the installing of the agent NE-P at the level of the interface SBI (step E3).

The invention therefore proposes a mechanism for managing the virtualized software functions VNF in a network in which these software functions VNF are managed according to a model-oriented approach (model-driven) rather than via static management elements EM created and installed manually by a human operator.

It thus extends the notion of SDN controller to the management of the virtualized functions VNF and introduces the new concept of VNF controller.

In one embodiment, the management method according to the invention further comprises:

a step of generating and installing a second software agent intended to be executed on invocation of the first software agent, this second agent being able to select the virtual machine so as to manage the load distribution of the virtualized software function.

This second software agent is thus used to manage in a flexible manner the dimensioning and the load distribution (or “scalability”) of the virtualized software function, just where the first software agent manages only the functionality itself of this virtual function.

It is indeed recalled that the virtualized software function can be implemented by one or more virtual machines, that is to say by one or more VNFC components.

Thus, when the VNF manager wishes to invoke a functionality, it invokes the first agent for this functionality, this first agent invoking the second agent so that the latter selects one or more virtual machines by taking the load distribution constraints into account.

In a particular embodiment, the second agent is configured to allow the registering of the virtual machines which implement the virtualized function VNF when they join the network.

Thus, in this particular embodiment, the invention is distinguished from the model-driven mechanism in that it allows:
Dynamic management of new virtualized software functions VNF when the latter are integrated into the network, by the automatic creation of the first agent, by enrichment of the SDN architecture; and
Management of the flexibility (scalability) of these virtualized software functions by the second agent.

The various steps of the method for managing the virtualized software functions according to the invention are determined by instructions of computer programs.

Consequently, the invention also envisages a computer program, on an information medium, this program comprising instructions suitable for the implementation of the steps of a management method according to the invention.

This program can use any programming language, and be in the form of source code, object code, or of code intermediate between source code and object code, such as in a partially compiled form, or in any other desirable form.

The invention also envisages an information medium readable by a computer, and comprising instructions of a computer program such as mentioned hereinabove.

The information medium can be any entity or device capable of storing the program. For example, the medium can comprise a storage means, such as a ROM, for example a CD ROM or a microelectronic circuit ROM, or else a magnetic recording means, for example a hard disk.

Moreover, the information medium can be a transmissible medium such as an electrical or optical signal, which can be conveyed via an electrical or optical cable, by radio or by other means. The program according to the invention can in particular be downloaded over a network of Internet type.

Alternatively, the information medium can be an integrated circuit in which the program is incorporated, the circuit being adapted to execute or to be used in the execution of the method in question.

### BRIEF DESCRIPTION OF THE DRAWINGS

Other characteristics and advantages of the present invention will emerge from the description given hereinbelow, with reference to the appended drawings which illustrate an exemplary embodiment thereof devoid of any limiting character. In the figures:

FIG. 1 already described represents the NFV architecture of the current state of the art;

FIG. 2 already described represents the SDN architecture of the current state of the art;

FIGS. 3A and 3B already described illustrate the model oriented (“model-driven”) mechanism of the OpenDaylight technology;

FIG. 4A illustrates the main steps of a method for managing virtualized software functions in accordance with a particular embodiment of the invention; and

FIG. 4B illustrates a control device in accordance with a particular embodiment of the invention.

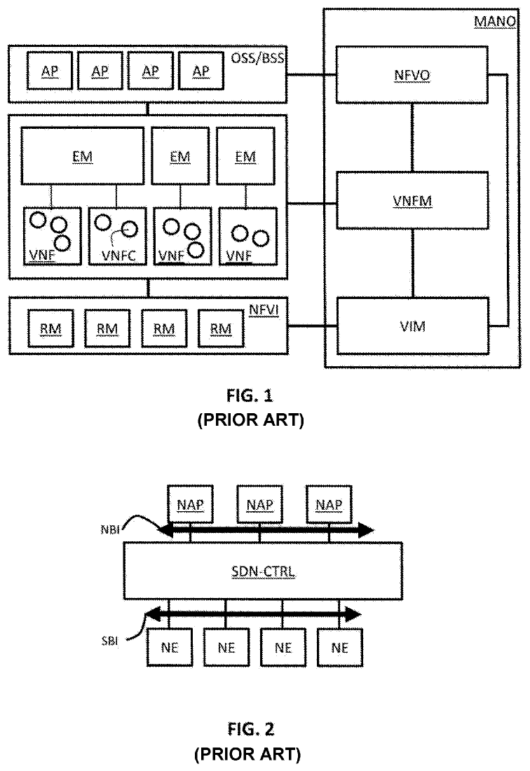

### DETAILED DESCRIPTION OF AN EMBODIMENT OF THE INVENTION

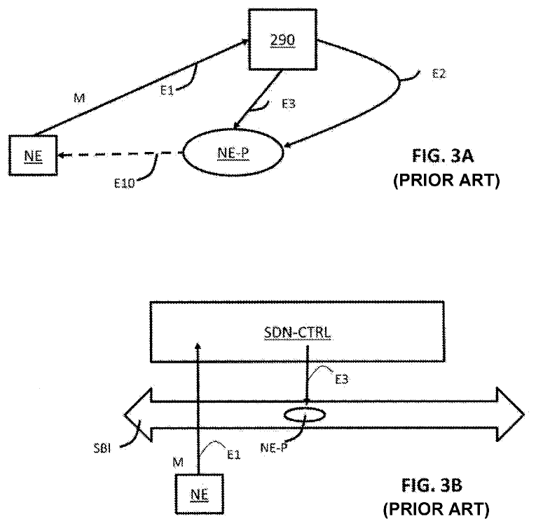

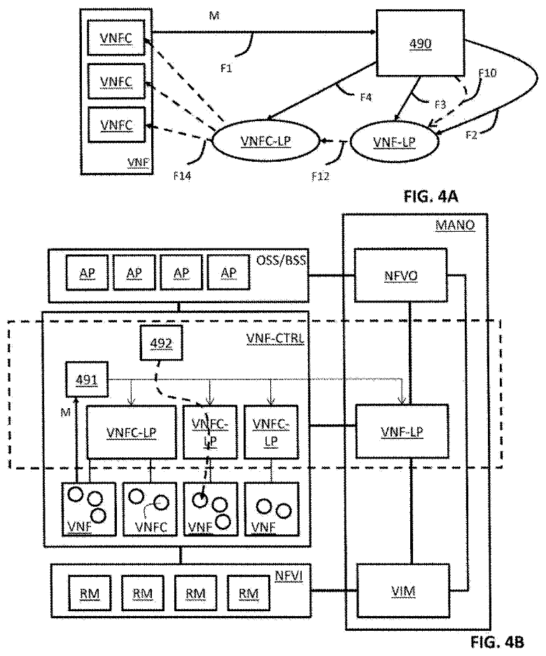

FIG. 4A represents the main steps of a method for managing virtualized software functions in accordance with the invention. This method makes it possible to integrate the management of the virtualized software functions VNF into the Opendaylight model-oriented architecture described with reference to FIG. 3A.

When a new virtualized function VNF has to be implemented in the network, this function registers itself with the control device (“VNF Controller”) VNF-CTRL in accordance with the invention by providing it with a data model M describing its functionalities (step F1).

In the course of a step F2, the control device VNF-CTRL generates a configuration interface (namely a java class) on the basis of the model M.

In the course of a step F3, the control device VNF-CTRL generates a first agent VNF-LP (“VNF-level plugin”) which implements the configuration interface generated in step F2 and installs this agent VNF-LP in the device VNF-CTRL.

In the course of a step F4, the device VNF-CTRL generates a second agent VNFC-LP (“VNFC-level plugin”) and installs this agent VNFC-LP in the control device.

This new agent VNFC-LP manages the load distribution of the virtualized software function VNF by dynamic selection of the virtual machines VFNC. It also allows the registering of the virtual machines VNFC which join the network to implement the virtualized function VNF.

When thereafter the control device VNF-CTRL wishes to invoke the new virtualized software function VNF, it uses the configuration interface generated in step F2 which calls the first agent VNF-LP (step F10). This agent VNF-LP calls the second agent VNFC-LP in the course of a step F12 and the agent VNFC-LP selects a virtual machine VFC as a function of the load distribution of the function VNF and executes it in the course of a step F14.

FIG. 4B represents a control device VNF-CTRL in accordance with the invention in its environment.

This VNF controller 490 comprises:
a module 491 able to receive the data model M emitted by a new virtualized function VNF when the latter joins the network, and to implement steps F2 to F4 already described to generate a configuration interface for this function, create and install the agents VNF-LP and VNFC-LP; and
a module 492 configured to, when it is called by an operational application AP of the OSS/BSS layer to invoke a virtualized software function VNF, invoke the agent VNFC-LP generated by the module 491 for this function. These agents VNFC-LP thus substitute themselves for the management elements EM defined within the framework of the NFV project.

Moreover, the agent VNF-LP installed by the module 491 constitutes a VNF manager in the sense of the NFV project, able, by interaction with the agents VNFC-LP, to take charge of the life cycle of the associated virtualized software function VNF.

1. A method for managing virtualized software functions in a communication network, said method comprising the following acts performed by a device:
receiving a data model describing functionality of a virtualized software function;
generating a configuration interface defining said functionality, said interface being configured to be used to invoke said virtualized software function; and
generating and installing a first software agent which implements said configuration interface, said first software agent being configured to allow, when it is invoked, calling of a virtual machine implementing said virtualized software function.

2. The management method as claimed in claim 1, which further comprises:
generating and installing a second software agent be executed on invocation of said first agent,
said second agent being able to select said virtual machine so as so as to manage load distribution of said virtualized software function.

3. The management method as claimed in claim 2, wherein said second agent is configured to allow registering of the virtual machines implementing said virtualized function VNF.

4. A device for controlling the virtualized software functions in a communication network, said device comprising:
a computer or integrated circuit configured to perform acts comprising:
receiving a data model describing functionality of a virtualized software function;
generating a configuration interface defining said functionality, said interface being configured to be used to invoke said virtualized software function;
generating and installing a first software agent which implements said configuration interface, said first agent being configured to allow, when it is invoked, calling of a virtual machine implementing said virtualized software function;
calling a virtual machine implementing said virtualized software function to invoke said virtualized software function.

5. The device as claimed in claim 4, wherein the computer or integrated circuit is configured further to perform acts comprising:
generating and installing a second software agent configured to be executed on invocation of said first agent,
said second agent being able to select said virtual machine so as to manage load distribution of said virtualized software function.

6. The device as claimed in claim 5, wherein said second agent is configured to allow the registering of the virtual machines implementing said virtualized function.

7. The device as claimed in claim 4, wherein said first agent constitutes a manager in the sense of a network function virtualization project.

8. A non-transitory computer-readable medium comprising instructions stored thereon, which when executed by a computing device configure the computing device to perform a method for managing virtualized software functions in a communication network, wherein the instructions configure the device to perform acts comprising:
receiving a data model describing functionality of a virtualized software function;
generating a configuration interface defining said functionality, said interface being configured to be used to invoke said virtualized software function; and
generating and installing a first software agent which implements said configuration interface, said first software agent being configured to allow, when it is invoked, calling of a virtual machine implementing said virtualized software function.
